(19) United States
(12) Patent Application Publication
(10) Pub. No.: US 2021/0339656 A1
(43) Pub. Date: Nov. 4, 2021

(54) ADAPTER ELEMENT FOR A ROTARY DEVICE

(71) Applicant: Aguti Produktentwicklung & Design GmbH, Langenargen (DE)

(72) Inventor: Christian ROGG, Wasserburg (DE)

(73) Assignee: Aguti Produktentwicklung & Design GmbH, Langenargen (DE)

(21) Appl. No.: 16/864,262

(22) Filed: May 1, 2020

(51) Int. Cl. B60N 2/14; B60N 2/015

(52) U.S. Cl. CPC B60N 2/14; B60N 2/015

(57) ABSTRACT

Adapter element for a rotary devices provided to connect a vehicle seat to a vehicle in a rotationally movable manner, wherein the adapter element is configured to be arranged between a rotary unit of the rotary device and the vehicle seat or between the rotary unit of the rotary device and the vehicle. The adapter element has a mounting mechanism configured for attaching the adapter element to a fastening mechanism of the vehicle seat and/or to a fastening mechanism of the vehicle. The fastening mechanism is present in a defined fastening diagram on the vehicle seat or on the vehicle. The mounting mechanism is configured such that the adapter element is attachable onto two different fastening diagrams of one or more vehicle seats and/or onto two different fastening diagrams of one or more vehicles.

### FIELD OF THE INVENTION

The present invention relates to an adapter element for a rotary device.

### BACKGROUND OF THE INVENTION

Rotary devices for a vehicle seat, in order to configure the vehicle seat to be rotatable about an axis perpendicular to a vehicle floor, are known. Known rotary devices comprise a rotary unit, a superstructure and a substructure, wherein the rotary unit is arranged between the superstructure and the substructure. The superstructure and the substructure in each case comprise mounting elements in order to mount the rotary device firstly onto the vehicle, for example, onto a vehicle floor, and secondly onto the vehicle seat so that the rotary device is present between the vehicle and the vehicle seat.

In this case, known vehicles and vehicle seats respectively comprise a fastening diagram which is accordingly present firstly to be complementary to the vehicle seat and to the vehicle and secondly to be complementary to the superstructure and to the substructure on known rotary devices. A drawback herein is that, as a result, the known rotary devices are attachable only on a specific fastening diagram, for example, only on a specific type thereof from one manufacturer. When a further vehicle or a further vehicle seat, for example, from a different manufacturer, has a different fastening diagram, the rotary device is not able to be mounted thereon and/or has to be adapted thereto.

### SUMMARY OF THE INVENTION

The object of the present invention is to provide an adapter element, a rotary device being attachable thereby onto different fastening diagrams of one or more vehicle seats and/or one or more vehicles, and/or to provide an improved rotary device which is attachable onto fastening diagrams of one or more vehicles.

The present invention is based on an adapter element for a rotary device, wherein the rotary device is provided to connect a vehicle seat to a vehicle in a rotationally movable manner, wherein the adapter element is configured to be arranged between a rotary unit of the rotary device and the vehicle seat or between the rotary unit of the rotary device and the vehicle, wherein the adapter element has a mounting mechanism, wherein the mounting mechanism is configured for attaching the adapter element to a fastening mechanism of the vehicle seat and/or to a fastening mechanism of the vehicle, wherein the fastening mechanism is present in a defined fastening diagram on the vehicle seat or on the vehicle.

The fastening mechanism is present, in particular, in a fixed fastening diagram on the vehicle seat or on the vehicle.

A bore pattern or a hole pattern is to be regarded as a fastening diagram, for example. The fastening mechanism of a fastening diagram are configured, for example, so as to be distributed as bores on a predetermined circle of holes. A fastening diagram advantageously comprises a plurality of fastening mechanisms, for example, at least two, in particular, at least or just three, fastening mechanisms, for example, at least, or, in particular, just, four fastening mechanisms. A fastening mechanism is configured, for example, as a bore, as a pin, for example, as a threaded pin and/or as a bolt. A fastening diagram advantageously comprises fastening mechanisms spaced apart from one another. For example, all of the fastening mechanisms of a fastening diagram are present spaced apart from one another. For example, all of the fastening mechanisms of a fastening diagram are configured equally, for example, the bores, the pins or the bolts are present in an identical manner.

Advantageously, the mounting mechanism is configured such that the adapter element, in particular, is able to be arranged, in particular, directly or immediately, for example, without a further adapter device, onto two, three, four, five, six, seven, eight, nine, ten, eleven, twelve or more fastening diagrams, which are, in particular, different from one another, of one or more vehicle seats and/or one or more vehicles.

The essence of the present invention is that the mounting mechanism is configured such that the adapter element is attachable onto two different fastening diagrams of one or more, in particular different, vehicle seats and/or onto two different fastening diagrams of one or more, in particular different, vehicles. As a result, a rotary device is attachable solely by the adapter element in a relatively simple manner and, in particular, in a variable manner onto different fastening diagrams, so that a relatively complex and costly adaptation of the rotary device is not necessary.

By way of example, the adapter element is configured to be arranged between a superstructure of the rotary device and the vehicle seat or a substructure of the rotary device and the vehicle. For example, the adapter element comprises an attachment mechanism, wherein the attachment mechanism is configured for attaching the adapter element to the rotary unit of the rotary device, to the superstructure of the rotary device and/or to the substructure of the rotary device.

Preferably, the mounting mechanism is configured such that the adapter element is attachable, in particular, onto two different fastening diagrams, in particular, of two different vehicle seats and/or, in particular, onto two different fastening diagrams, in particular of two different vehicles.

It is also advantageous if the mounting mechanism is configured mirror-symmetrically, in particular, axially symmetrically. Preferably, the mounting mechanism is arranged mirror-symmetrically, in particularly, axially symmetrically on the adapter element. Advantageously, the mounting mechanism is present mirror-symmetrically relative to a mirror plane which runs and/or is located transversely, in particular perpendicularly, to a main plane of the adapter element. Advantageously, the adapter element is able to be arranged with the main plane, in particular, bearing against the vehicle seat and/or against the vehicle. Advantageously, in the arranged state of the adapter element a mirror plane and/or a mirror axis of the mounting mechanism of the adapter element runs in the direction of travel of the vehicle and/or in the seating direction of the vehicle seat. For example, the mounting mechanism is configured mirror-symmetrically relative to a single mirror plane.

It is further proposed that the mounting mechanisms are present as mounting openings. Advantageously, in particular, all of the mounting mechanisms are configured as mounting openings. The mounting openings are present, for example, as mounting holes, in particular, entirely penetrating the adapter element. The mounting openings are configured, for example, as continuous mounting holes on the adapter element. Preferably, the mounting openings are arranged mirror-symmetrically, in particular axially symmetrically, on the adapter element. For example, a mounting opening is present as a bore, in particular, as a through-bore, on the adapter element.

Moreover, it proves advantageous if the adapter element is configured in the form of an adapter plate, wherein the mounting openings are configured on, for example, three, in particular four, separate regions of the adapter plate, wherein the mounting openings are configured on a first and on a second region of the separate regions, in particular, exclusively as slots. The regions of the adapter element are advantageously configured to be spaced apart from one another.

For example, the adapter element comprises three, in particular four, regions which are separate from one another and on which the mounting openings are present. Preferably, in each case two of the, for example, four regions are located opposite one another, viewed toward a center of the adapter element, for example, toward a central axis and/or a central plane of the adapter element, in particular, toward a center of the adapter plate. For example, the adapter plate is present in a rectangular shape and the regions are configured in corner regions of the adapter plate. For example, the adapter element is present as a plate, for example, as a metal plate, in particular, as a steel plate.

The mounting openings, in particular, all of the mounting openings, are advantageously configured as slots on two, in particular more than two, of the regions. For example, one, two, four or more, in particular three, mounting openings are present on a region and in each case are configured as a slot.

It also proves advantageous if a slot of the first region and a slot of the second region extend in the same direction, viewed in the longitudinal extent of the respective slot. A slot of the first region and a slot of the second region advantageously extend parallel to one another, viewed in the longitudinal extent of the respective slot. The longitudinal extent of the slot, in particular, is to be regarded as transversely, for example, in a transverse direction, relative to a bore direction of the slots. The bore direction of the slots is advantageously a direction of extent of the slots through the adapter element from a main plane of the adapter element to a second opposing main plane of the adapter element spaced apart therefrom. It is further proposed that a third and a fourth region is present, and the third and the fourth region comprise a mounting opening in the form of a slot and a mounting opening in the form of a bore. The bore is advantageously configured to be cylinder-shaped, in particular, cylindrically. The third and the fourth region comprise, in particular, in each case a single mounting opening in the form of a slot. Preferably, the third and the fourth region comprise a mounting opening which has a meandering contour, for example, a meander-like contour, for example, a free-form contour. Advantageously, the meandering contour of the mounting opening may be seen from a plan view of a main plane of the adapter element.

It further proves advantageous if the first and the second region are configured to the rear, in the mounted state on the vehicle and/or in the mounted state on the vehicle seat, viewed in the direction of travel of the vehicle. Advantageously, the third and the fourth region are configured to the front, in the mounted state on the vehicle and/or on the vehicle seat, viewed in the direction of travel of the vehicle. A longitudinal extent of a slot of the mounting mechanism, in the arranged state of the adapter element on the vehicle and/or on the vehicle seat, is preferably arranged transversely to a direction of travel of the vehicle.

An advantageous embodiment of the present invention is a rotary device for a vehicle seat, wherein the rotary device is configured to connect a vehicle seat to a vehicle in a rotationally movable manner, wherein the adapter element forms the superstructure of the rotary device and/or the adapter element forms the substructure of the rotary device. As a result, the rotary device itself is already prepared for being attached onto different fastening diagrams.

The superstructure and/or the substructure are advantageously integrally configured with the adapter element.

It also proves advantageous if the superstructure and the substructure of the rotary device are configured identically. For example, the superstructure and the substructure are configured mirror-symmetrically to one another. Advantageously, the superstructure and the substructure are configured identically and arranged mirror-symmetrically, in particular, axially symmetrically, to one another on the rotary device. Advantageously, the superstructure and/or the substructure is configured as a stamped part. For example, the superstructure and/or the substructure is configured from metal, in particular, from steel and/or iron.

Further proposed as advantageous embodiments of the present invention are a vehicle seat having an adapter element and/or a rotary device according to one of the preceding embodiments, or a vehicle having an adapter element and/or a rotary device according to one of the preceding embodiments.

### BRIEF DESCRIPTION OF THE DRAWINGS

Various exemplary embodiments are described in more detail by means of the following schematic drawings, specifying further details and advantages.

FIG. 1 shows an adapter element according to the present invention in a plan view;

FIG. 2 shows a rotary device having an adapter element in a perspective view from the top rear side;

FIG. 3 shows the rotary device of FIG. 2 in a plan view;

FIG. 4 shows the rotary device of FIG. 2 in a view from the front; and

FIG. 5 shows the rotary device of FIG. 2 in a side view.

### DETAILED DESCRIPTION OF THE INVENTION

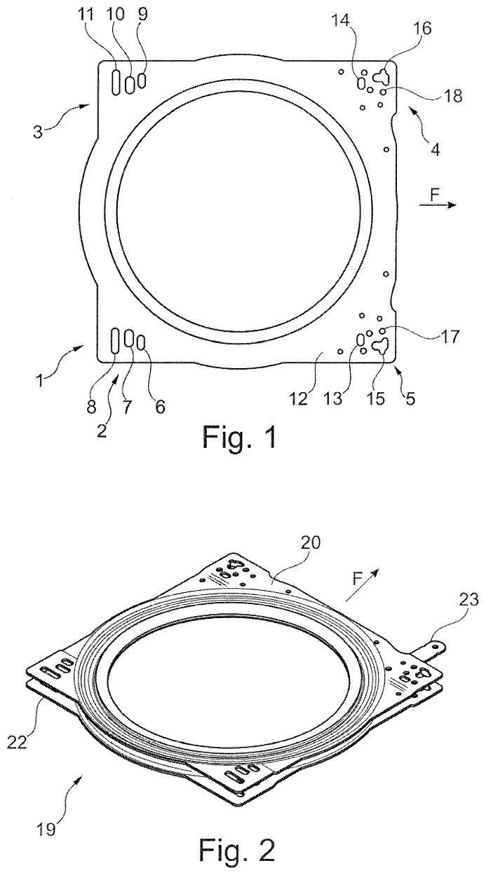

FIG. 1 shows an adapter element according to the present invention in the form of an adapter plate 1. The adapter plate 1 is of plate-shaped configuration and, in particular, present in a rectangular shape. Mounting mechanisms in the form of through-holes are configured on corner regions 2 to 5. The through-holes penetrate a thickness of the adapter plate 1 which in FIG. 1 extends, advantageously entirely, into the sheet plane. Advantageously, the drawing plane forms a main plane of the adapter plate 1. An outer face 12 of the adapter plate 1 extends, for example, in the main plane. For example, the outer face 12 of the adapter plate 1 forms the main plane.

In a first and second corner region 2, 3, the mounting mechanisms are configured in the form of slots 6 to 8 and/or 9 to 11. Advantageously, all of the mounting mechanisms, in particular, through-holes of the first and second corner region 2, 3, are configured as a slot 6 to 11. Advantageously, in each case a slot 6 to 8 of the first corner region 2 is present in an identical manner to a further, in particular, a single further, slot 9 to 11 of the second corner region 3. A longitudinal extent of the slots 8 to 11 of the first and the second corner region 2, 3 is configured, for example, transversely, in particular, perpendicularly, to a width extent of the adapter plate 1. Advantageously, all of the slots of the first and the second corner region 2, 3 extend parallel to one another in the longitudinal extent thereof.

Advantageously, the adapter plate 1 is mounted in the direction of travel F on a vehicle or a vehicle seat (respectively not shown). The first and the second corner region 2, 3 are advantageously present mirror-symmetrically to one another relative to a mirror plane, which extends in the direction of travel F. Preferably, the first and the fourth corner region 2, 5 are present mirror-symmetrically to the second and third corner region 3, 4 relative to the mirror plane. Advantageously, the adapter plate 1 is configured mirror-symmetrically relative to the mirror plane.

The third and the fourth corner region 4, 5 advantageously comprise mounting mechanisms, in particular, through-holes, which are configured firstly as a slot 13, 14, as a free-form bore 15, 16 and, in particular, as a conventional cylinder-shaped bore 17, 18. The free-form bores 15, 16 advantageously extend transversely, in particular perpendicularly, to the outer face 12 of the adapter plate 1 in the direction of a through-passage through the adapter plate 1. The free-form bores 15, 16 advantageously comprise a meandering contour which extends, for example, in a plane of the outer face 12. The free-form bores 15, 16 are configured, in particular arranged, on the adapter plate 1 mirror-symmetrically relative to the mirror plane, for example. A longitudinal extent of the slots 13, 14 of the third and fourth corner region 4, 5 is configured, for example, transversely, in particular perpendicularly, to a width extent of the adapter plate 1. Advantageously, all of the slots 6 to 11, 13, 14 of the four corner regions 2 to 5 extend parallel to one another in the longitudinal extent thereof.

FIGS. 2 to 5 show a rotary device 19 comprising a superstructure 20, a rotary unit 21 and a substructure 22. Moreover, for example, a control lever 23 may be arranged on the rotary unit 19, a rotational position of the rotary unit 21 and thus a position of the superstructure 20 relative to the substructure 22 being able to be fixed thereby.

The superstructure 20 and the substructure 22 of the rotary device 19 are advantageously configured in an identical manner. For example, both the superstructure 20 and the substructure 22 comprise the mounting mechanism arrangement of the adapter plate 1 of FIG. 1. For example, the adapter plate 1 is part of the superstructure 20 and/or the substructure 22. Hereinafter, corresponding to the variants cited above, the reference numerals of the adapter plate 1 are used identically for the rotary device 19.

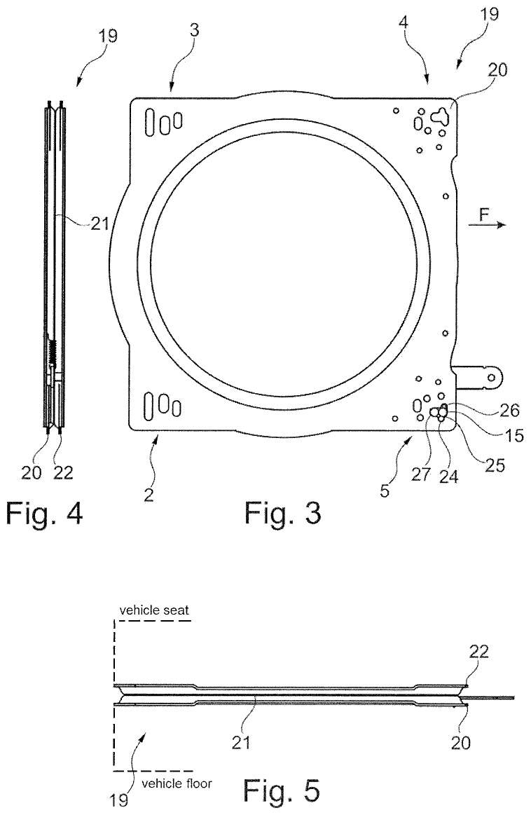

In FIG. 3, it is schematically shown in the corner region 5 how the free-form bore 15 is advantageously configured such that four different fastening mechanisms in the form of fastening bolts 24 to 27 of, in particular, four different fastening diagrams are able to be arranged onto the free-form bore 15. As a result, the rotary device 19 is configured, in particular, for flexible mounting on four different fastening diagrams.

List of Reference Numerals

| | |
|---|---|
| 1 | Adapter plate |
| 2 | Corner region |
| 3 | Corner region |
| 4 | Corner region |
| 5 | Corner region |
| 6 | Slot |
| 7 | Slot |
| 8 | Slot |
| 9 | Slot |
| 10 | Slot |
| 11 | Slot |
| 12 | Outer face |
| 13 | Slot |
| 14 | Slot |
| 15 | Free-form bore |
| 16 | Free-form bore |
| 17 | Bore |
| 18 | Bore |
| 19 | Rotary device |
| 20 | Superstructure |
| 21 | Rotary unit |
| 22 | Substructure |
| 23 | Control lever |
| 24 | Fastening bolt |
| 25 | Fastening bolt |
| 26 | Fastening bolt |
| 27 | Fastening bolt |

1. An adapter element for a rotary device, wherein the rotary device is provided to connect a vehicle seat to a vehicle in a rotationally movable manner, wherein the adapter element is configured to be arranged between a rotary unit of the rotary device and the vehicle seat or between the rotary unit of the rotary device and the vehicle, wherein the adapter element has a mounting mechanism configured for attaching the adapter element to a fastening mechanism of the vehicle seat and/or to a fastening mechanism of the vehicle, wherein the fastening mechanism is present in a defined fastening diagram on the vehicle seat or on the vehicle,
wherein the mounting mechanism is configured such that the adapter element is attachable onto two different fastening diagrams of one or more vehicle seats and/or onto two different fastening diagrams of one or more vehicles.

2. The adapter element as claimed in claim 1, wherein the mounting mechanism is configured mirror-symmetrically.

3. The adapter element as claimed in claim 1, wherein the mounting mechanism is present as mounting openings.

4. The adapter element as claimed in claim 3, wherein the adapter element is configured in the form of an adapter plate, wherein the mounting openings are configured on separate regions of the adapter plate, wherein the mounting openings are configured on a first and on a second region as slots.

5. The adapter element as claimed in claim 4, wherein a slot of the first region and a slot of the second region extend in the same direction, viewed in the longitudinal extent of the respective slot.

6. The adapter element as claimed in claim 4, wherein a third and a fourth region are present, and the third and the fourth region comprise a mounting opening in the form of a slot and a mounting opening in the form of a bore.

7. The adapter element as claimed in claim 4, wherein the first and the second region are configured to the rear, in the mounted state on the vehicle and/or on the vehicle seat, viewed in the direction of travel of the vehicle.

8. A rotary device for a vehicle seat, wherein the rotary device is configured to connect a vehicle seat to a vehicle in a rotationally movable manner, wherein the rotary device includes an adapter element that forms a superstructure of the rotary device and/or the adapter element forms a substructure of the rotary device.

9. The rotary device for a vehicle seat as claimed in claim 8, wherein the superstructure and the substructure of the rotary device are configured identically.

10. A vehicle seat having an adapter element as claimed in claim 1.

11. A vehicle having an adapter element as claimed in claim 1.

12. The adapter element as claimed in claim 2, wherein the mounting mechanism is configured axially symmetrically.

13. A vehicle seat having a rotary device as claimed in claim 8.

14. A vehicle having a rotary device as claimed in claim 8.
